(19) United States
(12) Patent Application Publication
(10) Pub. No.: US 2007/0104506 A1
(43) Pub. Date: May 10, 2007

(54) Toner cartridge and method of making it and method of remanufacturing a toner cartridge

(76) Inventors: Nitin Phadnis, Brookfield, CT (US); Wayne Upright, Thousand Oaks, CA (US)

Correspondence Address: HARNESS, DICKEY & PIERCE, P.L.C., P.O. BOX 828, BLOOMFIELD HILLS, MI, 48303, US

(21) Appl. No.: 11/497,035

(22) Filed: Jul. 31, 2006

Related U.S. Application Data
(60) Provisional application No. 60/704,499, filed on Aug. 1, 2005.

(51) Int. Cl. G03G 15/00

(52) U.S. Cl. 399/109

(57) ABSTRACT

A method remanufacturing a toner cartridge in accordance with an aspect includes separating a roller section from a toner section of the toner cartridge, replacing/reconditioning/cleaning those parts of the toner cartridges that require replacement/reconditioning/cleaning, charging the hopper section with toner, applying a heat activated adhesive to one or both of the hopper section and the roller section of the toner cartridge and applying energy to heat the heat activated adhesive to activate it to seal the hopper section and roller section together. In a variation, a second (e.g., new) hopper section is used instead of the hopper section separated from the roller section. A toner cartridge and method of manufacturing it in accordance with an aspect includes applying a heat activated adhesive to one or both of the hopper section and the roller section of the toner cartridge and applying energy to heat the heat activated adhesive to activate it to seal the hopper section and roller section together. In an aspect, the energy is ultrasonic energy and in an aspect, the ultrasonic energy is applied using an ultrasonic welder. In an aspect, the heat activated adhesive is a thermo-bond film adhesive.

### CROSS-REFERENCE TO RELATED APPLICATIONS

This application claims the benefit of U.S. Ser. No. 60/704,499, filed Aug. 1, 2005.

### FIELD

The present disclosure relates to toner cartridges, their manufacture and remanufacture.

### BACKGROUND

The statements in this section merely provide background information related to the present disclosure and may not constitute prior art.

Toner cartridges typically include a hopper section, that is charged with toner, and a roller section affixed to the hopper section. The hopper section and roller sections are often secured together such as with clips or by ultrasonic welding or by friction welding.

A model of a typical ultrasonic welding apparatus 100 such as is available from Branson Ultrasonics is shown in FIG. 1. Typical components of ultrasonic plastic welding apparatus 100 include an ultrasonic transducer 102, a booster 104, and a horn 106. Booster 104 is mechanically coupled to transducer 102 and horn 106 and is mounted inside a carriage (actuator) that consists of a pneumatic cylinder. Electrical energy from a power supply 101 at a frequency is converted to mechanical energy by the transducer 102. The transducer 102, booster 104, and horn 106 are all mechanically tuned to match the power supply electrical input frequency. The mechanical energy converted in the transducer 102 is transmitted to a welding load (plastic parts such as the hopper and roller section of a toner cartridge) through the booster 104 and the horn 106. The booster 104 and the horn 106 perform the functions of transmitting the mechanical energy as well as transforming mechanical vibrations from the transducer 102 by a gain factor. Booster and horn gains take an output amplitude (from the transducer 102) and factor this amplitude up or down.

The mechanical vibration that results on the surface of the horn is the motion that performs the task of welding the parts together. Essentially an axial displacement is produced by the transducer 102, modified in gain by the booster 104, and again modified in gain by the horn 106. The carriage/actuator brings down the stack (consisting of the converter, booster and horn) to bear upon the plastic parts being welded and applies a preset amount of pressure on the parts. As the weld clamp force reaches a set value, the vibrations will increasingly be transmitted to the top plastic piece, causing it to move up and down in consonance with the horn and hit the bottom plastic piece, which is held stationary in a fixture. The resultant molecular friction causes the plastic parts to melt at the interface. The parts are held together under pressure after the vibration ceases and the plastic is allowed to re-solidify and form a bond.

### SUMMARY

A toner cartridge and method of manufacturing it in accordance with an aspect includes applying heat activated adhesive to one or both of the hopper section and the roller section of the toner cartridge and applying energy to heat the heat activated adhesive to activate it and seal the hopper section and roller section together.

In an aspect, the heat activated adhesive is a thermo-bond film adhesive.

In an aspect, ultrasonic energy is applied to the heat activated adhesive to heat it. In an aspect, the ultrasonic energy is applied by using an ultrasonic welder.

A method of remanufacturing a toner cartridge in accordance with an aspect includes separating a roller section from a toner section of the toner cartridge, replacing/reconditioning/cleaning those parts of the toner cartridges that require replacement/reconditioning/cleaning, charging the hopper section with toner, applying a heat activated adhesive to one or both of the hopper section and the roller section of the toner cartridge and applying energy to heat the heat activated adhesive to activate it and seal the hopper section and roller section together. In an aspect, a second hopper section is used in lieu of the hopper section separated from the roller section.

In an aspect, the heat activated adhesive is a thermo-bond film adhesive.

In an aspect, ultrasonic energy is applied to the heat activated adhesive to heat it. In an aspect, ultrasonic energy is applied by using an ultrasonic welder.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a prior art ultrasonic welding apparatus;

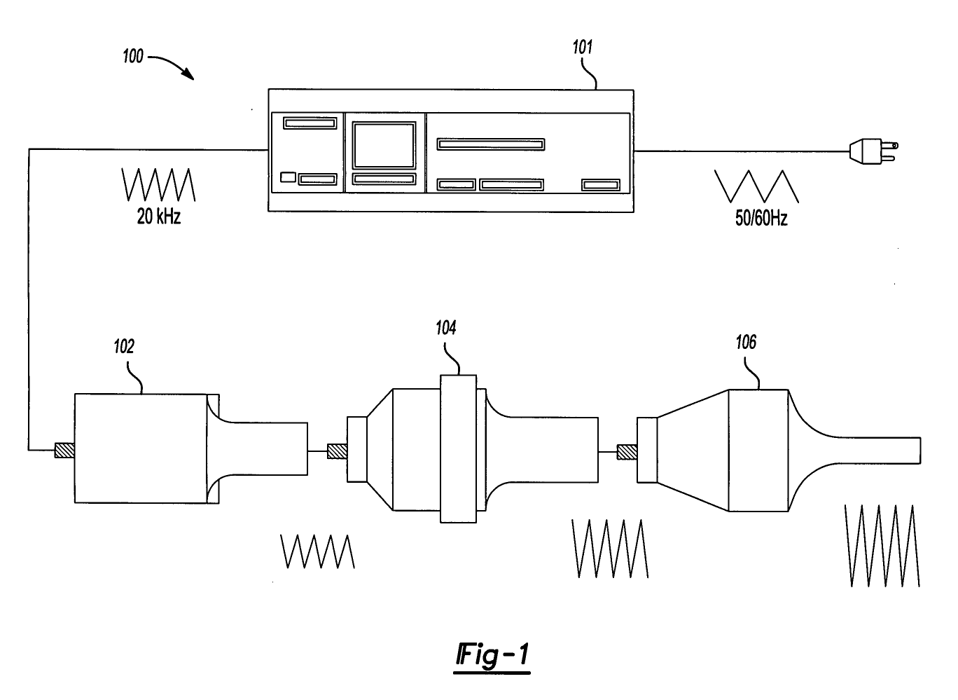

FIG. 2 is a perspective view of a toner cartridge manufactured in accordance an aspect; and

FIG. 3 is a perspective exploded view of the toner cartridge of FIG. 2.

### DETAILED DESCRIPTION

The following description of the preferred embodiment(s) is merely exemplary in nature and is in no way intended to limit the invention, its application, or uses.

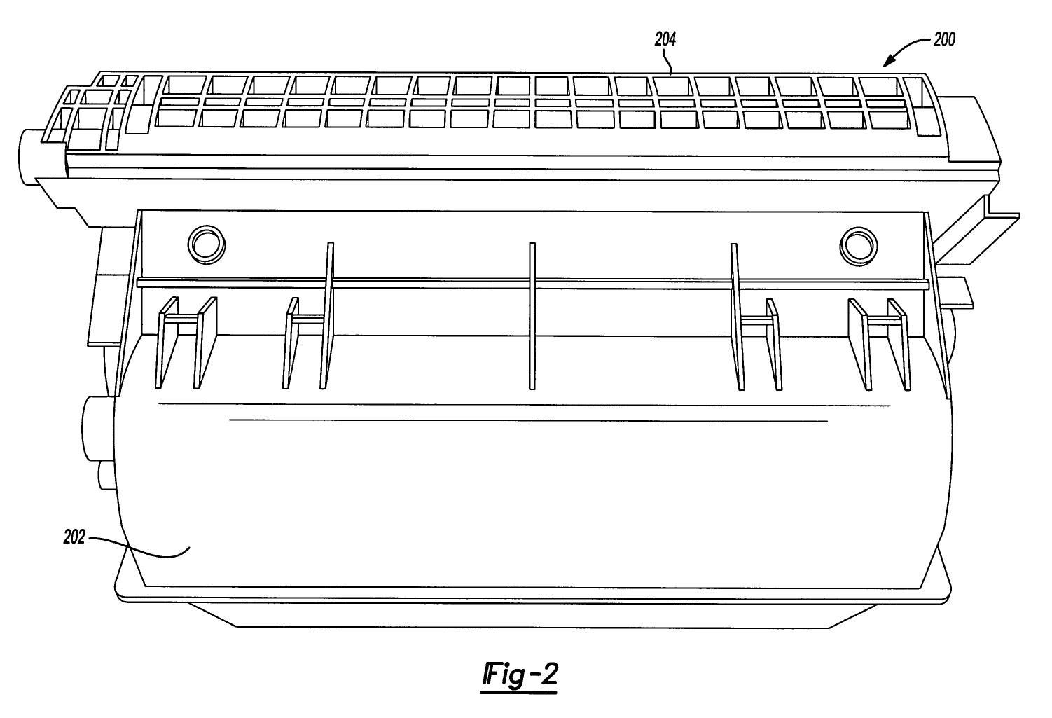

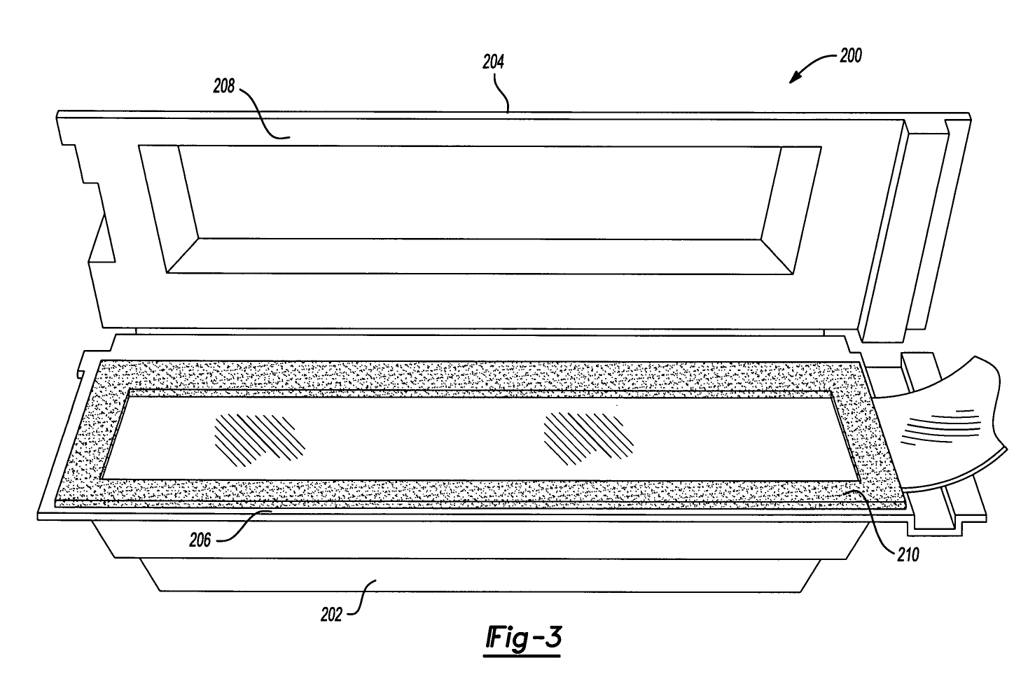

Referring to FIGS. 2 and 3, a toner cartridge 200 in accordance with an aspect is shown. Toner cartridge 200 includes a hopper section 202 and a roller section 204. Hopper section 202 has a mating surface 206 that abuts a corresponding mating surface 208 of roller section 204 when hopper section 202 and roller section 204 are secured together. In the embodiment shown in FIGS. 2 and 3, hopper section 202 and roller section 204 are rectangular as are their respecting mating surfaces 206, 208.

With reference to FIG. 3, in manufacturing toner cartridge 200, heat activated adhesive, such as a thermo-bond film adhesive 210, is applied to one or both of mating surface 206 of hopper section 202 and mating surface 208 of roller section 204. Thermo-bond film adhesive 210 may illustratively be a thermoplastic adhesive bonding film. One such thermoplastic adhesive bonding film is Bonding Film 615 made by 3M. It should be understood that thermo-bond film 210 may be any type of film that is heat activated to provide a bond. Illustratively thermo-bond film 210 is die cut to conform to mating surface 206 of hopper section 202.

Hopper section 202 and roller section 204 are brought together so that mating surface 206 of hopper section 202 and mating surface 208 of roller section 204 butt against each other with thermo-bond film 210 disposed therebetween. Energy is then applied to heat thermo-bond film 210 to seal hopper section 202 to roller section 204. Toner cartridge 200 thus has hopper section 202 and roller section 204 sealed together by activated heat activated adhesive, such as thermo-bond film 210. By activated, it is meant that energy was applied to the heat activated adhesive to activate it.

In an aspect, the source of energy is a source of ultrasonic energy, such as ultrasonic welder ultrasonic welder 100. In this aspect, hopper section 202 is illustratively mounted in a fixture to clamp it during the bonding process and the fixture is mounted on a base plate of ultrasonic welder 100. Hopper section 202 and roller section 204 are then brought together, such as by placing roller section 204 on hopper section 202. A cycle of ultrasonic welder 100 is then initiated. When the cycle is initiated, horn 106 bears down on roller section 204 and horn 206 passes high frequency vibrations to roller section 204 causing ultrasonic vibrations to occur at an interface of mating surfaces 206, 208 of hopper section 202 and roller section 204. These ultrasonic vibrations heat thermo-bond film adhesive 210 to activate it and seal hopper section 202 and roller section 204 together. The cycle of ultrasonic welder 100 is then terminated and toner cartridge 200 allowed to stand for a sufficient time to allow any molten material at the interface of mating surfaces 206, 208 of hopper section 202 and roller section 204 to solidify. Horn 106 is then retracted and toner cartridge 200 removed from ultrasonic welder 100.

In an aspect, thermo-bond film adhesive 210 may illustratively have a protective liner over a contact adhesive surface. When thermo-bond film adhesive 210 is placed on hopper section 202, this liner is first removed and the thermo-bond film adhesive 210 applied to hopper section 202 with the contact adhesive surface of thermo-bond film 210 contacting mating surface 206 of hopper section 202. It should be understood that a thermo-bond film adhesive 210 can alternatively be applied to roller section 204 with the contact adhesive surface of thermo-bond film adhesive 210 contacting mating surface 208 of roller section 204. It should be understood that two thermo-bond film adhesive 210 can be applied, with one applied to hopper section 202 and the other applied to roller section 204. In which case, the contact adhesive surface of each of the thermo-bond film adhesives 210 are applied to the respective mating surfaces 206, 208 of hopper section 202 and roller section 204.

The foregoing process can also be used in remanufacturing a toner cartridge. Referring to toner cartridge 200 in its assembled state, hopper section 202 and roller section 204 are separated. Parts of toner cartridge 200 are replaced/reconditioned/cleaned in conventional fashion as appropriate. Hopper section 202 and roller section 204 are then sealed together in the manner described above by using a heat activated adhesive, such as thermo-bond film adhesive 210, disposed between the hopper section 202 and roller section 204 and energy is applied to the heat activated adhesive to activate it. In an illustrative aspect, ultrasonic energy is applied to the heat activated adhesive, such as to the thermo-bond film adhesive 210, to activate it, such as by using ultrasonic welder 100.

In a variation, instead of reusing the existing hopper section 202 when remanufacturing toner cartridge 200, a second hopper section, such as a new hopper section, is used.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of remanufacturing a toner cartridge, comprising:
separating a roller section of the toner cartridge from a hopper section of the toner cartridge;
charging the hopper section with toner;
applying a heat activated adhesive to one or both of the hopper section and the roller section and then bringing the hopper section and the roller section together with the heat activated adhesive disposed between mating surfaces of the hopper section and the roller section; and
then applying energy to the heat activated adhesive to activate it to seal the hopper section and roller section together.

2. The method of claim 1 wherein applying energy to the heat activated adhesive includes applying ultrasonic energy to it.

3. The method of claim 2 wherein applying ultrasonic energy to the heat activated adhesive includes applying energy to the heat activated adhesive using an ultrasonic welder.

4. The method of claim 3 wherein the heat activated adhesive is a thermo-bond film adhesive.

5. The method of claim 4 wherein the thermo-bond film adhesive has a contact adhesive surface that contacts the mating surface of the hopper section or the roller section to which the thermo-bond film adhesive is applied prior to applying the energy.

6. The method of claim 1 including replacing/reconditioning/cleaning those parts of the toner cartridge that require replacing/reconditioning/cleaning after separating the hopper and roller sections and before bringing the hopper and roller sections together.

7. A method of remanufacturing a toner cartridge, comprising:
separating a roller section of the toner cartridge from a hopper section of the toner cartridge;
charging a second hopper section with toner;
applying a heat activated adhesive to one or both of the second hopper section and the roller section and then bringing the second hopper section and the roller section together with the heat activated adhesive disposed between mating surfaces of the second hopper section and the roller section; and
then applying energy to the heat activated adhesive to activate it to seal the second hopper section and roller section together.

8. The method of claim 7 wherein applying energy to the heat activated adhesive includes applying ultrasonic energy to it.

9. The method of claim 8 wherein applying ultrasonic energy to the heat activated adhesive includes applying energy to the heat activated adhesive using an ultrasonic welder.

10. The method of claim 9 wherein the heat activated adhesive is a thermo-bond film adhesive.

11. The method of claim 10 wherein the thermo-bond film adhesive has a contact adhesive surface that contacts the mating surface of the hopper section or the roller section to which the thermo-bond film adhesive is applied prior to applying the energy.

12. The method of claim 7 including replacing/reconditioning/cleaning those parts of the toner cartridge that require replacing/reconditioning/cleaning after separating the hopper and roller sections and before bringing the hopper and roller sections together.

13. A method of manufacturing a toner cartridge, comprising:
charging a hopper section with toner;
applying a heat activated adhesive to one or both of the of the hopper section and a roller section and then bringing the hopper section and the roller section together with the heat activated adhesive film disposed between mating surfaces of the hopper section and the roller section; and
then applying energy to the heat activated adhesive to activate it to seal the hopper section and roller section together.

14. The method of claim 13 wherein applying energy to the heat activated adhesive includes applying ultrasonic energy to the heat activated adhesive.

15. The method of claim 14 wherein applying ultrasonic energy to the heat activated adhesive includes applying energy to the heat activated adhesive using an ultrasonic welder.

16. The method of claim 15 wherein the heat activated adhesive is thermo-bond film adhesive.

17. The method of claim 16 wherein the thermo-bond film adhesive has a contact adhesive surface that contacts the mating surface of the hopper section or the roller section to which the thermo-bond film adhesive is applied prior to applying the energy.

18. A toner cartridge, comprising a hopper section and a roller section sealed together by an activated heat activated adhesive.

19. The apparatus of claim 18 wherein the heat activated adhesive is a thermo-bond film adhesive.
